(19) United States
(12) Patent Application Publication
(10) Pub. No.: US 2011/0136031 A1
(43) Pub. Date: Jun. 9, 2011

(54) FUEL CELL SYSTEM AND ELECTRONIC DEVICE

(76) Inventors: Yuuichi SATO, Tokyo (JP); Daisuke Watanabe, Chigasaki-shi (JP); Genta Oomichi, Yokohama-shi (JP)

(21) Appl. No.: 13/015,105

(22) Filed: Jan. 27, 2011

Related U.S. Application Data
(63) Continuation of application No. PCT/JP2009/063425, filed on Jul. 28, 2009.

(30) Foreign Application Priority Data
Jul. 29, 2008 (JP) 2008-195088

(51) Int. Cl. H01M 8/04

(52) U.S. Cl. 429/442

(57) ABSTRACT

According to an embodiment, in a fuel cell system, a power generator generates electric power with fuel in a fuel cell unit, first and second temperature detectors detect an ambient temperature and a generator temperature of a power generator in the fuel cell unit, respectively. A storage unit stores control temperatures corresponding to a plurality of temperature ranges to which the ambient temperature belong, and a control temperature setting unit determines corresponding one of the temperature ranges based on the ambient temperature, and sets one of the control temperatures which corresponds to the one of the determined temperature ranges. A control unit controls the amount of fuel supplied to the power generator according to the result of comparing the one of the control temperatures with the output of the second temperature detector.

### CROSS REFERENCE TO RELATED APPLICATIONS

This is a Continuation Application of PCT Application No. PCT/JP2009/063425, filed Jul. 28, 2009, which was published under PCT Article 21(2) in Japanese.

This application is based upon and claims the benefit of priority from Japanese Patent Application No. 2008-195088, filed Jul. 29, 2008; the entire contents of which are incorporated herein by reference.

### FIELD

Embodiments described herein relate generally to a fuel cell system, and an electronic device using the fuel cell system as a power supply.

### BACKGROUND

Electronic devices such as a cell-phone and portable information terminal have become miniaturized. Accompanying the miniaturization of electronic devices, a fuel cell has been tried to use as a power supply of such devices. A fuel cell has advantages that electric power is generated simply by supplying fuel and air, and continuously generated merely by replacing fuel. Hence, a miniaturized fuel cell can be used as a power supply of a miniaturized electronic device.

Recently, a direct methanol fuel cell (DMFC) has been noticed as a fuel cell. A DMFC is classified, by a method of supplying liquid fuel, into a gas supply type which supplies gaseous fuel, an active fuel type such as a liquid supply type which supplies liquid fuel, and a passive type such as an internal vaporization type which vaporizes liquid fuel stored in a fuel container within a cell. Among these fuel cells, a passive type is particularly advantageous for miniaturizing a DMFC.

In a passive type DMFC, a membrane electrode assembly (a fuel cell) which comprises a fuel electrode, an electrolyte membrane, and an air electrode is provided on a fuel container formed as a box-shaped vessel made of resin.

In a type of fuel cell which connects a fuel cell and a fuel container of DMFC through a flow path, liquid fuel is supplied from a fuel container to a fuel cell through a flow path, and the liquid fuel supply amount can be adjusted based on the shape and diameter of a flow path. In a particular type of fuel cell, the liquid fuel supply amount can be adjusted by supplying liquid fuel from a fuel container to a flow path by using a pump. Instead of a pump, it is possible to use an electric field forming unit, which produces an electro-osmotic flow in a flow path.

In a fuel cell system using such a DMFC as a main power generator, it is necessary to control the temperature inside a DMFC increased by the heat of a heating part to be a preset reference temperature, for ensuring stable power generation. The temperature of the heating part is likely to be influenced by a temperature around a fuel cell system. Actually, the temperature of the heating part is obtained by adding a temperature increase caused by generation of power in a DMFC to the temperature around a fuel cell system.

When a reference temperature of the heating part is assumed to be 45° C., for example, and the heating part is assumed to be heated to 60° C. by the influenced by the temperature around the fuel cell system, the temperature of the heating part is controlled close to a reference temperature in a wide temperature range, while adjusting the fuel supply amount to the heating part, by changing the operating time of on-timer and off-timer. However, such a control may be performed in a high temperature range over 60° C., and the temperature becomes very high at the maximum. This may cause adverse effects to an electronic device using a fuel cell system. On the other hand, when the temperature of the heating part is greatly decreased from a reference temperature by the influence of the temperature around a fuel cell system, the temperature of the heating part is controlled to be 45° C. or lower in a wide temperature range. The temperature becomes very low at the minimum, and the power-generating capacity of the power generator is decreased, and the temperature of the heating part may be further decreased. As a result, the output and power generation efficiency of a DMFC may be extremely decreased.

### BRIEF DESCRIPTION OF THE DRAWINGS

FIG. 1 is a block diagram of a fuel cell system according to a first embodiment;

FIG. 2 is a magnified sectional view of a structure of a fuel cell unit shown in FIG. 1;

FIG. 3 is a perspective view of a fuel distribution mechanism used in the fuel cell unit shown in FIG. 2;

FIG. 4 is a table showing the contents of a control temperature setting table according to the first embodiment stored in a storage shown in FIG. 1;

FIGS. 5A and 5B show waveforms for explaining the operation of the fuel cell system shown in FIG. 1 based on the control temperature setting table shown in FIG. 4;

FIG. 6 is a table showing the contents of a control temperature setting table according to a second embodiment stored in the storage shown in FIG. 1; and

FIGS. 7A and 7B show waveforms for explaining the operation of the fuel cell system shown in FIG. 1 based on the control temperature setting table shown in FIG. 6.

### DETAILED DESCRIPTION

Hereinafter, a fuel cell system according to embodiments will be explained with reference to accompanying drawings.

In general, according to an embodiment, there is provided a fuel cell system which comprises a fuel cell unit including a power generator which generates an electric power with fuel, a first temperature detector which detects an ambient temperature, a second temperature detector which detects a temperature of a power generator of the fuel cell unit, a storage unit which stores control temperatures corresponding to a plurality of temperature ranges to which the ambient temperature belong. The fuel cell system further comprises a control temperature setting unit and a control unit. The control temperature setting unit determines one of temperature ranges based on the detected ambient temperature, and sets a control temperature corresponding to the one of the determined temperature ranges. The control unit controls the amount of fuel supplied to the power generator according to the result of comparing the control temperature with the output of the second temperature detector.

### First Embodiment

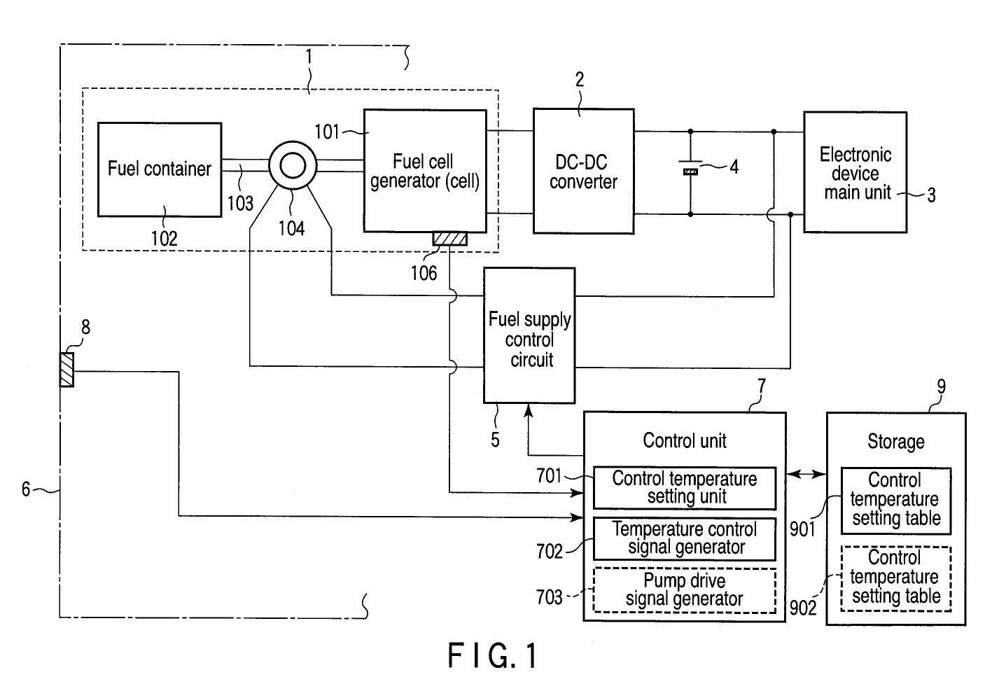

FIG. 1 is a block diagram of a fuel cell system according to a first embodiment.

In FIG. 1, a reference number 1 denotes a fuel cell unit (DMFC). The fuel cell unit 1 comprises a fuel cell generator (cell) 101 constituting an electromotive part, a fuel container 102 which receives liquid fuel, a flow path 103 connecting the fuel container 102 and fuel cell generator (cell) 101, and a pump 104 as a fuel transfer control unit for supplying liquid fuel from the fuel container 102 to the fuel cell generator (cell) 101.

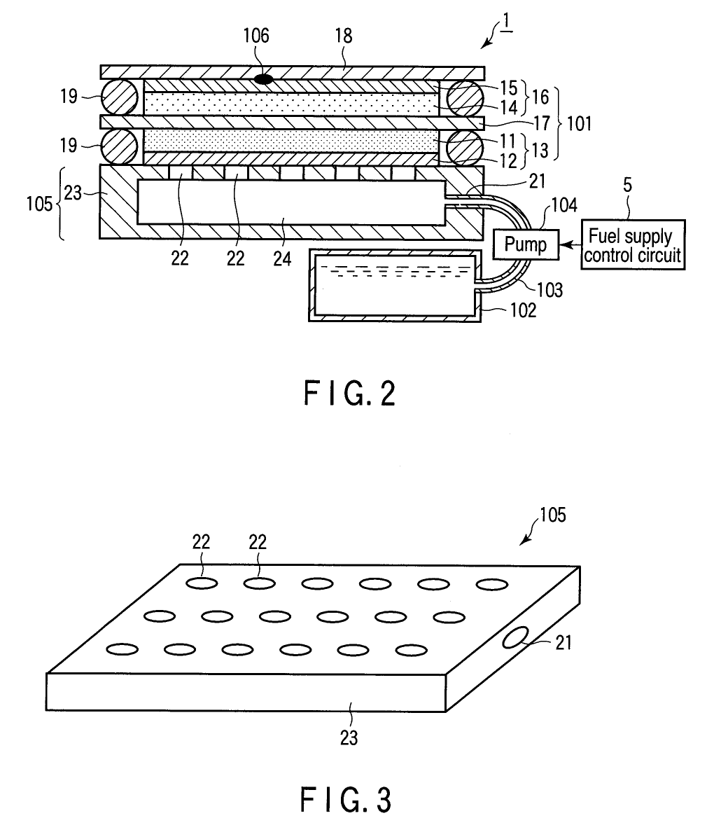

FIG. 2 is a sectional view for explaining the fuel cell unit 1.

As shown in FIG. 2, the fuel cell generator 101 comprises an anode (a fuel electrode) 13 having an anode catalyst layer 11 and an anode gas diffusion layer 12, a cathode (an air electrode/oxidant electrode) 16 having a cathode catalyst layer 14 and a cathode gas diffusion layer 15, and membrane electrode assembly (MEA) comprising a proton (hydrogen ion) conductive electrolyte membrane 17 held by the anode catalyst layer 11 and cathode catalyst layer 14.

As a catalyst contained in the anode catalyst layer 11 and cathode catalyst layer 14, there are platinum group elements such as Pt, Ru, Rh, Ir, Os, and Pd, and alloyed metal containing platinum group elements. The anode catalyst layer 11 preferably contains Pt−Ru and Pt−Mo highly resistant to methanol and carbon monoxide. The cathode catalyst layer 14 preferably contains Pt and Pt−Ni. A catalyst is not limited to these metals, and may use Various substances with catalytic activity. A catalyst may be a carrier catalyst using a conductive carrier, such as carbon material, or a non-carrier catalyst.

As a proton conductive material forming the proton conductive electrolyte membrane 17, there are fluorine series resin, such as perfluorosulfonic acid polymer having sulfonic acid radical (Nafion of DuPont) or Fleomin (Asahi Glass), or organic material, such as hydrocarbon series resin having sulfonic acid radical, or inorganic material, such as tungsten acid and phosphotungstic acid. The proton conductive electrolyte membrane 17 is not limited to these materials.

The anode gas diffusion layer 12 laminated on the anode catalyst layer 11 supplies fuel evenly to the anode catalyst layer 11, and serves as a power collector of the anode catalyst layer 11. The cathode gas diffusion layer 15 laminated on the cathode catalyst layer 14 supplies oxidant evenly to the cathode catalyst layer 14, and serves as a power collector of the cathode catalyst layer 14. The anode gas diffusion layer 12 and cathode gas diffusion layer 15 are made of porous material.

If necessary, a conductive layer is laminated on the anode gas diffusion layer 12 and cathode gas diffusion layer 15. Such a conductive layer uses a porous layer (e.g. mesh) made of a conductive metal such as Au and Ni, a porous membrane, or a composite material made by coating a conductive metal such as a foil or stainless steep (SUS) with a highly conductive metal such as gold. A rubber O-ring 19 is inserted between the electrolyte membrane 17 and fuel distribution mechanism 10 described later. The O-ring 19 prevents leakage of fuel and oxidant from the fuel cell generator 101.

A cover plate 18 has an opening (not shown) for taking in air as oxidant. A moisture-retentive layer and a surface layer are provided between the cover plate 18 and cathode 16 if, necessary. The moisture-retentive layer contains some of water generated by the cathode catalyst layer 14, prevents transpiration of the water, and accelerates uniform diffusion of air to the cathode catalyst layer 14. The surface layer adjusts the amount of air to be taken in, and has a plurality of air inlets with different sizes adjusted to meet the amount of air to be taken in.

A fuel distribution mechanism 105 is provided in the anode (a fuel electrode) 13 of the fuel cell generator 101. The fuel distribution mechanism 105 is connected to the fuel container 102 through a liquid fuel flow path 103 like a pipe.

The fuel container 102 contains liquid fuel suitable for the fuel cell generator 101. As liquid fuel, there are methanol fuel such as methanol solution with various density and pure methanol. Liquid fuel is not limited to methanol fuel, and may be ethanol fuel such as ethanol solution and pure ethanol, propanol fuel such as propanol solution and pure propanol, glycol fuel such as glycol solution and pure glycol, dimethyl ether, formic acid or other liquid fuel. Either way, the fuel container 102 contains liquid fuel suitable for the fuel cell generator 101.

Fuel is supplied from the fuel container 102 to the fuel distribution mechanism 105 through the flow path 103. The flow path 103 is not limited to a pipe independent of the fuel distribution mechanism 105 and fuel container 102. For example, in a structure in which the fuel distribution mechanism 105 and fuel container 102 are stacked in one body, the flow path may be a fuel passage connecting these units. The fuel distribution mechanism 105 may be connected to the fuel container 102 through the flow path 103.

As shown in FIG. 3, the fuel distribution mechanism 105 is provided with at least one fuel inlet port 21 to take in the fuel through the flow path 103, and a fuel distribution plate 23 having two or more fuel outlet ports 22 to discharge fuel and its vaporized component. As shown in FIG. 2, a cavity 24 is provided inside the fuel distribution plate 23, as a passage for the fuel supplied from the fuel inlet port 21. The fuel outlet ports 22 are directly connected to the cavity 24 as a fuel path.

The fuel injected into the fuel distribution mechanism 105 through the fuel inlet port 21 flows into the cavity 24, and is guided to the fuel outlet ports 22 through the cavity 24 as a fuel path. The fuel outlet ports 22 may be a vapor-liquid separator (not shown), which transmits only a vaporized component of the fuel, and does not transmit a liquid component. In this configuration, a vaporized component of fuel is supplied to the anode (fuel electrode) 13 of the fuel cell generator 101. A vapor-liquid separator may be provided as a vapor-liquid separation film between the fuel distribution mechanism 105 and anode 13. A vaporized component of fuel is discharged from the fuel outlet ports 22 to some parts of the anode 13.

A plurality of fuel outlet ports 22 is provided on the surface contacting the anode 13 of the fuel distribution plate 23, so that the fuel can be supplied to the entire fuel cell generator 101. The number of fuel outlet ports 22 may be two or more, and is preferably 1 to 10 per square centimeter to make the fuel supply amount uniform on the surface of the fuel cell generator 101.

A pump 104 as a fuel transfer control unit is inserted into the flow path 103 connecting the fuel distribution mechanism 105 and fuel container 102. The pump 104 is not a circulation pump to circulate fuel, but a fuel supply pump to supply fuel from the fuel container 102 to the fuel distribution mechanism 105. By supplying fuel at need by using such a pump 104, the fuel supply amount can be exactly controlled. From the viewpoint of exactly supplying small amount of fuel and reducing the size and weight of the pump 104, it is preferable to use a rotary vane pump, electro-osmotic flow pump, diaphragm pump, or squeeze pump. A rotary vane pump feeds liquid by rotating a vane with a motor. An electro-osmotic pump uses a sintered porous material such as silica to cause an electro-osmotic phenomenon. A diaphragm pump feeds fuel by driving a diaphragm with an electromagnet or piezoelectric ceramics. A squeeze pump feeds fuel by squeezing by pressing a part of a flexible fuel flow path. From the viewpoint of driving power and dimensions, it is most preferable to use an electro-osmotic pump or a diaphragm pump having piezoelectric ceramics.

A fuel supply control circuit 5 is connected to the pump 104 to control the pump 104. This will be described later.

In the above configuration, the fuel contained in the fuel container 102 is supplied to the fuel distribution mechanism 105 by the pump 104 through the flow path 103. The fuel is ejected from the fuel distribution mechanism 105, and supplied to the anode (fuel electrode) 13 of the fuel cell generator 101. In the fuel cell generator 101, the fuel is diffused by the anode gas diffusion layer 12, and supplied to the anode catalyst layer 11. When methanol fuel is used, methanol causes an internal reforming reaction expressed by the equation (1) in the anode catalyst layer 11. When pure methanol is used, methanol reacts with the water produced by the cathode catalyst layer 14 and water contained in the catalyst membrane 17, and causes the internal reforming reaction expressed by the equation (1), or causes an internal reforming reaction by other reaction mechanisms requiring no water.

CH₃OH+H₂O→CO₂+6H⁺+6e⁻ (1)

The electron (e⁻) produced by the reaction is led to the outside through a power collector, and supplied to the load side as a so-called output, and led to the cathode (air electrode) 16. The proton (H⁺) produced by the internal reforming reaction expressed by the equation (1) is led to the cathode 16 through the catalyst membrane 17. Air is supplied as oxidant to the cathode 16. The electron (e⁻) and proton (H⁺) led to the cathode 16 react and produce water according to the following equation (2).

6e⁻+6H⁺+(3/2)O₂ →3H₂O (2)

As shown in FIG. 1, the fuel cell unit 1 configured as described above is provided with a temperature sensor 106 as a second temperature detector in the fuel cell generator (cell) 10. The temperature sensor 106 detects the temperature of the heating part of the fuel cell generator (cell) 101. The temperature sensor 106 is composed of a thermistor or thermocouple, for example, and is provided in the cathode (air electrode) 16 of the fuel cell generator (cell) 101 shown in FIG. 2. The temperature sensor 106 sends a control unit 7 a detection signal corresponding to the heat temperature.

Around the fuel cell unit 1, for example, in a case 6 containing the system, a temperature sensor 8 is provided as a first temperature detector. The temperature sensor 8 detects a temperature around the case 6, and sends the control unit 7 a detection signal corresponding to the ambient temperature. The ambient temperature detection signal is an actual value, or an estimated value estimated from an actual value around the fuel cell unit 1, when a temperature around the case 6 cannot be directly detected, for example. The control unit 7 will be explained later.

The fuel cell unit 1 is connected to a DC-DC converter (a voltage adjustment circuit) 2 as an output adjustment unit. The DC-DC converter 2 comprises a switching element, and an energy-storing element (both not shown). By the switching element and energy-storing element, the electrical energy generated by the fuel cell unit 1 is stored and discharged, and a voltage, which is produced by boosting the relatively low output voltage from the fuel cell unit 1 up to a sufficiently high voltage, is generated. The output of the DC-DC converter 2 is supplied to an auxiliary power supply 4.

A standard booster type DC-DC converter 2 is shown here. The converter may be a circuit type as long as boosting is possible.

The auxiliary power supply 4 is connected to the output terminal of the DC-DC converter 2. The auxiliary power supply 4 is chargeable by the output of the DC-DC converter 2, and supplies a current for a momentary load fluctuation in the electronic device main unit 3. When the fuel is exhausted and the fuel cell unit fails to generate power, the auxiliary power supply 4 is used as a power supply for driving the electronic device main unit 3. The auxiliary power supply 4 uses a rechargeable secondary cell (e.g. a lithium-ion rechargeable battery (LIB) or electric double layer capacitor).

The auxiliary power supply 4 is connected to the fuel supply control circuit 5. The fuel supply control circuit 5 controls the operation of the pump 104 by the power of the auxiliary power supply 4, and turns on/off the pump 104 based on an instruction from the control unit 7.

The control unit 7 is connected to the fuel supply control circuit 5.

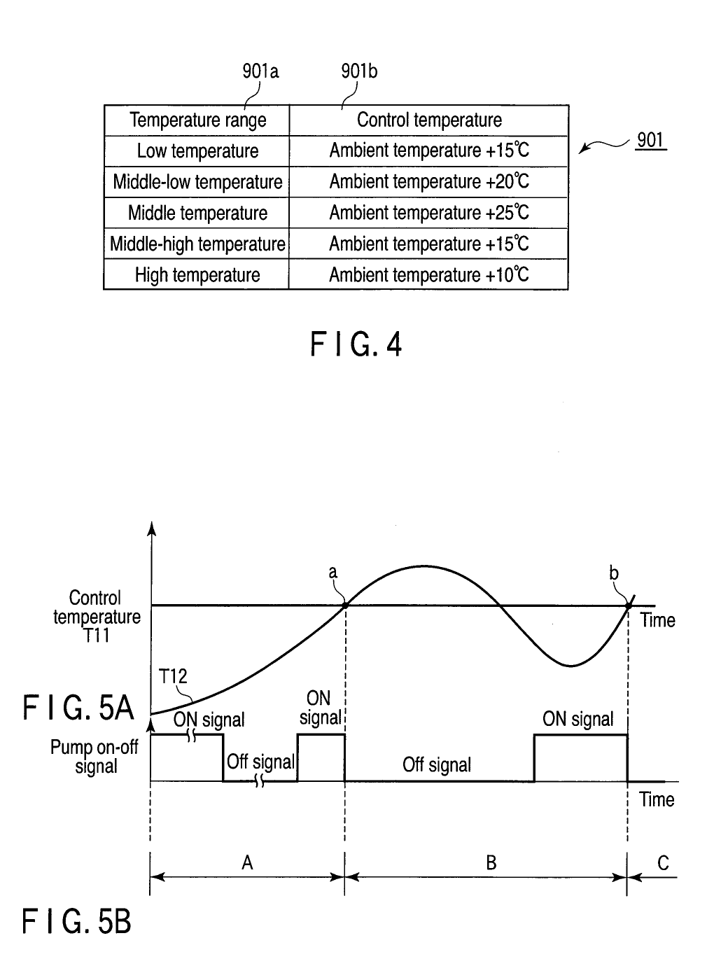

The control unit 7 controls the whole system, and is connected to storage 9. The storage 9 includes a control temperature setting table 901. The control temperature setting table 901 stores a temperature range 901a to which an ambient temperature belongs, and a control temperature (operating temperature) 901b for the temperature range 901a, as shown in FIG. 4. As shown in FIG. 4, each of the temperature range 901a is set based on a middle temperature of 25° C., for example. Low and high temperature ranges are set for the middle temperature range. A middle-low temperature range is set between the middle temperature range and low temperature range. A middle-high temperature range is set between the middle temperature range and high temperature range. For these low, middle-low, middle, middle-high and high temperature ranges, the control temperature 901b is set to the ambient temperature +15° C. for the low temperature range, +20° C. for the middle-low temperature range, +25° C. for the middle temperature range, +15° C. for the middle-high temperature range, and +10° C. for the high temperature range. A value added to the ambient temperature of the middle temperature range is the highest, and values added to the ambient temperatures of the low and high temperature ranges are lower. These value sets are based one following reasons. If the control temperature is unnecessarily high in the low temperature range, fuel is excessively supplied, and a crossover may occur. If the control temperature is unnecessarily high in the high temperature range, fuel is excessively supplied, and the heating part is overheated.

The temperatures set for the low, middle-low, middle, middle-high and high temperature ranges are just examples, and may be set depending on the capacity and characteristics of a fuel cell unit. Ambient temperatures are set for five ranges of low, middle-low, middle, middle-high and high range, but may be roughly set for three ranges of low, middle and high range, or may be set for five or more divided ranges.

The control unit 7 comprises a control temperature setting unit 701, and a temperature control signal generator 702. The control temperature setting unit 701 determines one of low, middle-low, middle, middle-high and high temperature ranges, and sets a control temperature corresponding to the determined temperature range, based on ambient temperatures detected by the temperature sensor, or temperatures around the case 6, by referring to the control temperature setting table 901 shown in FIG. 4. The temperature control signal generator 702 outputs a pump-on signal to determined the operating time of the pump 104 for controlling the fuel supply to the fuel cell generator 101, and a pump-off signal to determine the stop time of the pump 104. The temperature control signal generator 702 compares the output of the temperature sensor 106 with the control temperature set by the control temperature setting unit 701, and forcibly stops a pump-on signal (limit the pump-on signal generation time), and outputs a pump-off signal, when the output of the temperature sensor 106 exceeds the control temperature, and outputs a pump-on signal again, when the pump stop time set for a pump-off signal passes.

Next, the operation of the embodiment configured as described above will be explained.

When a temperature around the case 6 is detected as an ambient temperature by the temperature sensor 8, the control temperature setting unit 701 of the control unit 7 determines a temperature range based on the output of the temperature sensor 8 by referring to the control temperature setting table 901 shown in FIG. 4. In this case, when the ambient temperature is 25° C., it is determined to be a middle temperature range, and the ambient temperature +25° C. corresponding to the middle temperature range is set as a control temperature T11. By this setting, while the output (the temperature of the heating part) T12 of the temperature sensor 106 is lower than the control temperature T11 as shown by the waveform in FIG. 5A, the temperature control signal generator 702 alternately outputs a pump-on signal and pump-off signal. During the pump-on signal period, the pump 104 is driven by the fuel supply control circuit 5 for the operating time determined by the pump-on signal, and fuel is supplied to the fuel cell generator 101 through the flow path 103. During the pump-off signal period, the pump 104 is stopped by the fuel supply control circuit 5 for the pump stop time determined by the pump-off signal, and the fuel supply to the fuel cell generator 101 is stopped. In this state, when the temperature of the heating part of the fuel cell generator (cell) 101 increases, the output T12 of the temperature sensor 106 reaches the control temperature T11 (the point a in FIG. 5) due to the temperature increase in the fuel cell generator (cell) 101, the temperature control signal generator 702 outputs a pump-off signal (a pump-on signal is forcible stopped), the fuel supply control circuit 5 stops the pump 104, and the fuel supply to the fuel cell generator 101 is forcibly stopped. In this case, as in the period B, the fuel cell generator (cell) 101 continues generation of power by the residual fuel even after the stop of fuel supply, and the temperature of the heating part continuously increases, and then, the temperature decreases, and the output T12 of the temperature sensor 106 decreases. In this state, when the pump stop time set for a pump-off signal passes, the temperature control signal generator 702 outputs a pump-on signal again. Or, the pump-on signal and pump-off signal may be alternately output like the signal shown in the period A. Thereby, the pump 104 is driven by the fuel supply control circuit 5, fuel is supplied to the fuel cell generator 101 through the flow path 103, and the temperature of the heating part of the fuel cell generator (cell) 101 increases again to the control temperature T11. Thereafter, when the output T12 of the temperature sensor 106 reaches again the control temperature T11 (the point b in FIG. 5), the temperature control signal generator 702 outputs a pump-off signal (a pump-on signal is forcibly stopped) at this timing (refer to the period C). Thereafter, by repeating the similar operation, the temperature of the heating part of the fuel cell generator (cell) 101 is controlled to the control temperature T11.

As described above, the fuel cell generator 101 is controlled to the control temperature (operating temperature) set by the control temperature setting unit 701, and generates electric power. The power generated by the fuel cell generator 101 is boosted by the DC-DC converter 2, and supplied to the electronic device main unit 3. At the same time, the auxiliary power supply 4 is charged by the output of the DC-DC converter 2. The electronic device main unit 3 is operated by the power supplied from the DC-DC converter 2.

In the above description, the ambient temperature +25° C. corresponding to the middle temperature range is set as a control temperature. For the other low, middle-low, middle-high and high temperature ranges, temperatures are similarly controlled based on control temperatures set by referring to the control temperature setting table 901 shown in FIG. 4.

Therefore, the control temperature setting table 901 is previously prepared, a control temperature is set by referring the control temperature setting table 901 according to a temperature around a device, the control temperature is compared with the output of the temperature sensor 106. When the output of the temperature sensor 106 exceeds the control temperature, the temperature control signal generator 702 forcibly stops a pump-on signal (the pump-on signal generation time is reduced), outputs a pump-off signal, and controls the fuel supply amount to the fuel cell generator 101. Therefore, irrespective of the ambient temperature, the temperature of the heating part of the fuel cell generator 101 is controlled based on the control temperature set corresponding to the ambient temperature at that time, and particularly when the ambient temperature belongs to a high temperature range, the temperature of the heating part is controlled based on the control temperature corresponding to this ambient temperature belonging to the high temperature range, and the cell temperature is not highly increased at the highest, unlike the conventional cell. This avoids ill effects to an electronic device using a fuel cell system including the fuel cell unit 1. Further, even when the ambient temperature belongs to the low temperature range, the temperature of the heating part of the fuel cell generator 101 is controlled based on the control temperature set corresponding to the ambient temperature at this time. This prevents drop of power generation capacity due to non-increase of temperature, and a further temperature decrease in the heating part, disabling generation of power, as in a conventional system.

A fuel cell system according to the first embodiment is pre-produced, and evaluated as follows. In the evaluation, the system is compared with a conventional system. A fuel container is filled with pure methanol. A fuel cell generator generates certain electric power under the middle (25° C±10), low and high temperature conditions. Based on the output power obtained in this time, the output and heating temperature are measured for ten hours. The output and temperature fluctuation range for the 10-hour measurement is calculated as a standard deviation, and the value in the first modification system is obtained as a relative value in each temperature range by assuming a value in a conventional system to be 100. As a result, the embodiment system provides the output deviation of 101 and temperature deviation of 100 in the middle temperature range (25° C±10), for 100 in the conventional system, 72 and 52 in the low temperature range, and 83 and 85 in the high temperature range. Since the conventional system is designed to have an appropriate temperature in the middle temperature range, and the difference is not large. However, in the low and high temperature ranges, it is proved that the embodiment system can always supply appropriate fuel, and realize preferable power generation.

### Modification

In the first embodiment, the temperature control signal generator 702 forcibly stops a pump-on signal, and outputs a pump-off signal, when the output of the temperature sensor 106 exceeds a control temperature, and outputs a pump-on signal again when the pump stop time set for a pump-off signal passes. However, the temperature control signal generator may be configured to forcibly stop a pump-off signal (to reduce the pump-off signal generation time), and output a pump-on signal, when the output of the temperature sensor 106 decreases to be lower than a control temperature, and outputs a pump-on signal again when the pump operating time set for a pump-on signal passes. In this configuration, particularly, when the ambient temperature belongs the low temperature range, it is possible to prevent a drop of power generation capacity due to non-increase of temperature, a further temperature decrease in the heating part, and a failure in generation of power.

Of course, the temperature control signal generator 702 may be configured to switch the operations described in the first embodiment and modification, when the ambient temperature belongs to the high or low temperature range.

### Second Embodiment

In the first embodiment, a control temperature is set according to an ambient temperature, and the temperature of the heating part of the fuel cell generator is controlled based on the control temperature. In the second embodiment, a threshold temperature is set in addition to a control temperature, and the temperature of the heating part of the fuel cell generator is controlled based on the threshold temperature and control temperature.

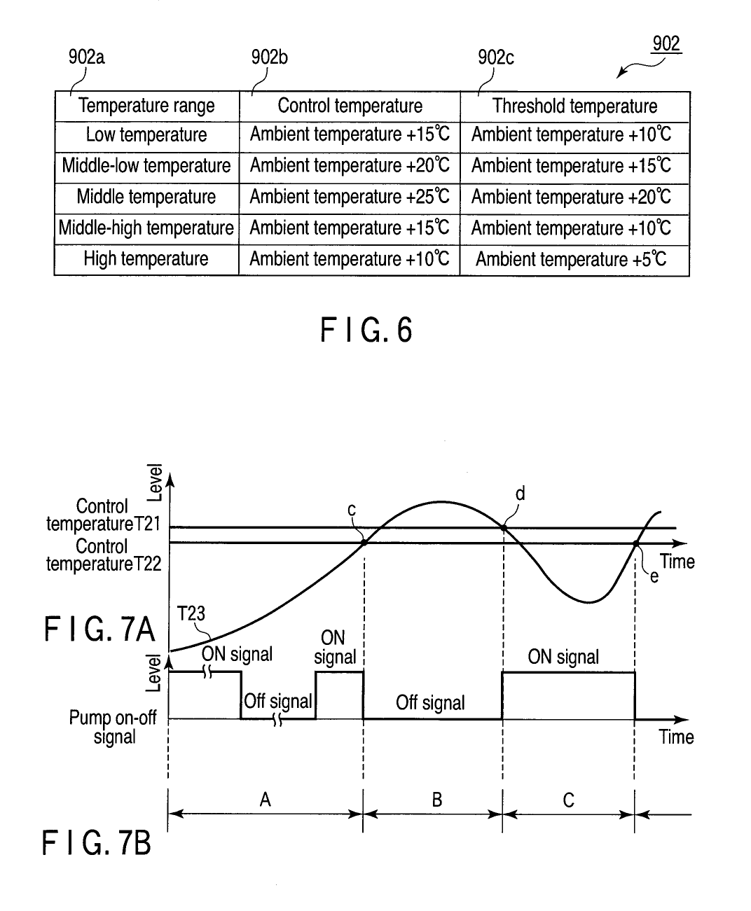

In the second embodiment, in FIG. 1, a control temperature setting table 902 is provided instead of the control temperature setting table 901. The temperature setting table 902 stores a temperature range 902a to which an ambient temperature belongs, a control temperature (operating temperature) 902b for the temperature range 902a, and a threshold temperature 902c for the temperature range 902a, as shown in FIG. 6. In this case, a setting standard of each temperature range of the temperature range 902a, and the setting of the control temperature 902b corresponding to each temperature range (low, middle-low, middle, middle-high and high temperature range) is the same as that in the control temperature setting table 901 shown in FIG. 4. The threshold temperature 902c is set corresponding to the low, middle-low, middle, middle-high and high temperature ranges. For these temperature ranges, the threshold temperature is set to the ambient temperature +10° C. for the low temperature range, ambient temperature +15° C. for the middle-low temperature range, ambient temperature +20° C. for the middle temperature range, ambient temperature +10° C. for the middle-high temperature range, and ambient temperature +15° C. for the high temperature range. In this case, the threshold temperature of each temperature range is set to lower than the control temperature of each temperature range (−5° C. in FIG. 6).

The temperature control signal generator 702 of the control unit 7 is configured to output a pump-on signal to determine the pump operating time, and a pump-off signal to determine the pump stop time. The temperature control signal generator 702 outputs a pump-on signal and pump-off signal for controlling the output of the temperature sensor 106 (the temperature of the heating part) for the control temperature (or threshold temperature) set by the control temperature setting unit 701. The temperature control signal generator 702 compares the output of the temperature sensor 106 with the above-mentioned control temperature (or the threshold temperature), and forcibly stops a pump-on signal, and outputs a pump-off signal, when the output of the temperature sensor 106 exceeds the threshold temperature. Contrarily, the temperature control signal generator 702 forcibly stops a pump-off signal, and outputs a pump-on signal, when the output of the temperature sensor 106 decreases to lower than the control temperature. Preferably, similar to the signal shown in the period A, the pump-on and pump-off signals are alternately output.

The others are the same as in FIG. 1.

In the above configuration, when the temperature around the case 6 is detected as an ambient temperature by the temperature sensor 8, the control temperature setting unit 701 of the control unit 7 refers to the control temperature setting table 902 shown in FIG. 6, and determines a temperature range based on the output of the temperature sensor 8. In this case, when the ambient temperature is 25° C., it is determined to be a middle temperature range, and the ambient temperature +25° C. corresponding to the middle temperature range is set as a control temperature T21, and the ambient temperature +20° C. is set as a threshold temperature T22. By this setting, while the output (the temperature of the heating part) T23 of the temperature sensor 106 is lower than the control temperature T22 (lower than the control temperature T21) set by the control temperature setting unit 701 as shown in the period A of FIG. 7, the temperature control signal generator 702 alternately outputs a pump-on signal and pump-off signal. During the pump-on signal period, the pump 104 is driven by the fuel supply control circuit 5 for the operating time determined by the pump-on signal, and fuel is supplied to the fuel cell generator 101 through the flow path 103. During the pump-off signal period, the pump 104 is stopped by the fuel supply control circuit 5 for the pump stop time determined by the pump-off signal, and the fuel supply to the fuel cell generator 101 is stopped. In this state, when the temperature of the heating pat of the fuel cell generator (cell) 101 increases, the output T23 of the temperature sensor 106 increases, and the output T23 of the temperature sensor 106 reaches the threshold temperature T22 (the point c in FIGS. 7A and 7B) due to the temperature increase in the fuel cell generator (cell) 101, the temperature control signal generator 702 outputs a pump-off signal (a pump-on signal is forcible stopped), the fuel supply control circuit 5 stops the pump 104, and the fuel supply to the fuel cell generator 101 is forcibly stopped. In this case, as shown in the period B, the fuel cell generator (cell) 101 continues generation of power by the residual fuel, and the temperature of the heating part continuously increases even after the stop of fuel supply, and then the temperature decreases, and the output T23 of the temperature sensor 106 decreases. When the temperature is decreased to the control temperature 21 (the point d in FIGS. 7A and 7B), the temperature control signal generator 702 outputs a pump-on signal (the pump-off signal generation time is educed), the fuel supply control circuit 5 drives the pump 104, and fuel is supplied to the fuel cell generator 101 through the flow path 103. The temperature of the heating part of the fuel cell generator (cell) 101 once decreases after the fuel supply is restarted, but thereafter, increases again to the control temperature T22 (refer to the period C). In the period C, similar to the signal shown in the period A, it is preferable that the pump-on signal and pump-off signal are alternately output. When the output T23 of the temperature sensor 106 reaches the threshold temperature 22 (refer to the point e in FIGS. 7A and 7B), the temperature control signal generator 702 outputs a pump-off signal (the pump-on signal is forcible stopped), the fuel supply control circuit 5 stops the pump 104, and the fuel supply to the fuel cell generator 101 is stopped. Thereafter, by repeating the similar operation, the temperature of the heating part of the fuel cell generator (cell) 101 is controlled to the value between the threshold temperature T22 and control temperature T21.

Therefore, the same effect as the first embodiment can be obtained in the above configuration. Further, the threshold temperature T22 is set lower than the control temperature 21. When the output T23 of the temperature sensor 106 reaches the threshold temperature T22, the pump-off signal is output, the pump 104 is stopped, and fuel supply to the fuel cell generator 101 is stopped. In other words, before the output T23 of the temperature sensor 106 reaches the control temperature T21, fuel supply to the fuel cell generator 101 is stopped. Therefore, the temperature increase in the heating part of the fuel cell generator 101, which is continuously increased by the residual fuel even after the stop of fuel supply, can be minimized. This prevents an unnecessary temperature increase in the heating part of the fuel cell generator 101.

### Third Embodiment

In the above embodiment, a control temperature is set according to an ambient temperature, and the temperature of the heating part of the fuel cell generator is controlled based on the control temperature. In the third embodiment, a voltage to drive a pump that is a fuel supplier is varied.

In the third embodiment, for example, an electro-osmotic pump (an electric-osmotic pump 104) is used for the pump 104 that is used as a fuel transfer control unit in FIG. 1. The electro-osmotic pump 104 has an electro-osmotic material made of a sintered porous material such as silica to cause electro-osmotic phenomenon, in the flow path 103, and is provided with an electrode at the ends of in the upstream and downstream of the electro-osmotic material. A predetermined voltage (a drive voltage) is applied across the upstream and downstream electrodes, and fuel is transferred into the flow path 103 through the electro-osmotic material. The electro-osmotic pump 104 can vary the amount of fuel transferred in the flow path 103 by changing the drive voltage applied across the electrodes.

The control unit 7 is provided with a pump drive signal generator 703 instead of the temperature control signal generator 702. The pump drive signal generator 703 sends a control signal to control the drive voltage of the electro-osmotic pump 104, to the fuel supply control circuit 5 based on the control temperature set by the control temperature setting unit 701. In this case, the pump drive signal generator 703 forcibly stops a pump-on signal, and outputs a pump-off signal, when the output (the temperature of the heading part) of the temperature sensor 106 exceeds the control temperature set by the control temperature setting unit 701, and forcibly stops a pump-off signal, and output a pump-on signal, when the output of the temperature sensor 106 decreases to lower than the control temperature.

The others are the same as in FIG. 1.

In the above configuration, a temperature around the case 6 is detected by the temperature sensor 8, the control temperature setting table 901 shown in FIG. 4 is referred to, and a temperature range is determined based on the output of the temperature sensor 8. In this case, when the ambient temperature is 25° C., it is determined to be a middle temperature range, and the ambient temperature +25° C. corresponding to the middle temperature range is set as a control temperature T11.

By this setting, when the output of the temperature sensor 106 decreases to lower than the control temperature, the pump drive signal generator 703 sets a great drive voltage for the electro-osmotic pump 104, increases the fuel supply amount to the fuel cell generator 101, and permits a temperature increase in the heating part. Contrarily, when the output of the temperature sensor 106 increases, the pump drive signal generator 703 sets a great drive voltage for the electro-osmotic pump 104, decreases the fuel supply amount to the fuel cell generator (cell) 101, and prevents a temperature increase in the heating part.

Therefore, the same effect as the first embodiment can be obtained in the above configuration.

The above third embodiment describes an example applied to the first embodiment. The invention may be realized by applying to the second embodiment. An electro-osmotic pump is used as a pump 104. The pump may be of the other types, as long as the amount of fuel supplied to the fuel cell generator 101 can be varied by changing the drive voltage.

The invention is not limited to the above embodiments. The invention may be modified in practical phase without departing from the essential characteristics.

According to the invention, there is provided a fuel cell system and electronic device, which supply optimum fuel against ambient temperature changes, and always provide stable power output.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuel cell system comprising:
a fuel cell unit including a power generator which generates an electric power with fuel;
a first temperature detector which detects an ambient temperature;
a second temperature detector which detects a generator temperature of a power generator in the fuel cell unit;
a storage unit which stores control temperatures corresponding to a plurality of temperature ranges to which the ambient temperature belong;
a control temperature setting unit which determines corresponding one of the temperature ranges defined in the storage unit, based on the detected temperature, and sets one of the control temperatures which corresponds to the one of the determined temperature ranges; and
a control unit which controls the amount of fuel supplied to the power generator according to the result of comparing the one of the control temperatures with the output of the second temperature detector.

2. The fuel cell system according to claim 1, which is incorporated in an electronic device as a power supply.

3. The fuel cell system according to claim 1, wherein the fuel cell unit comprises a fuel transfer control unit to supply fuel to the power generator, and the control unit controls time to generate an ON signal which determines time to operate the fuel transfer control unit, or time to generate an OFF signal which determines time to stop the fuel transfer control unit, according to the result of comparing the one of the control temperatures with the output of the second temperature detector.

4. The fuel cell system according to claim 1, wherein the fuel cell unit comprises a fuel transfer control unit to supply fuel to the power generator,
the control temperature setting unit sets the control temperature corresponding to the determined temperature range, and also set a threshold temperature, and
the control unit controls time to generate an ON signal which determines time to operate the fuel transfer control unit, and time to generate an OFF signal which determines time to stop the fuel transfer control unit, according to the results of comparing the one of the control temperatures and the threshold temperature with the output of the second temperature detector.

5. A fuel cell system comprising:
a fuel cell unit which comprises a power generator which generates an electric power with fuel, and a fuel transfer control unit which supplies fuel to the power generator;
a first temperature detector which detects an ambient temperature;
a second temperature detector which detects a temperature of a power generator of the fuel cell unit;
a storage unit which stores control temperatures corresponding to a plurality of temperature ranges to which the ambient temperature belong;
a control temperature setting unit which determines one of the temperature ranges defined in the storage unit based on the detected ambient temperature, and sets a control temperature corresponding to the determined one of the temperature ranges; and
a control unit which variably controls a drive voltage of the fuel transfer control unit according to the result of comparing the control temperature with the output of the second temperature detector.

6. The fuel cell system according to claim 5, which is incorporated in an electronic device as a power supply.
